(19) United States
(12) Patent Application Publication
(10) Pub. No.: US 2018/0174359 A1
(43) Pub. Date: Jun. 21, 2018

(54) FRAME DIFFERENCE GENERATION HARDWARE IN A GRAPHICS SYSTEM

(71) Applicant: MediaTek Inc., Hsinchu (TW)

(72) Inventors: Ying-Chieh Chen, Kaohsiung (TW); Shih-Chin Lin, Hsinchu (TW); Chih-Yu Chang, Hsinchu (TW)

(21) Appl. No.: 15/379,529

(22) Filed: Dec. 15, 2016

(51) Int. Cl. G06T 17/20; G06T 15/00; G06T 1/60

(52) U.S. Cl. CPC G06T 17/20; G06T 1/60; G06T 15/005

(57) ABSTRACT

A graphics system provides frame difference generator hardware for dynamically adjusting a frame rate. The graphics system includes a graphics processing unit (GPU), which generates frames containing tiles of graphics data. The frame difference generator hardware receives the graphics data of a tile of a current frame from the GPU, in parallel with a frame buffer that also receives the graphics data. The frame difference generator hardware computes a difference value between a first value computed from the graphics data and a second value representing a corresponding tile of a previous frame, and accumulates difference values computed from multiple tiles of the current frame and the previous frame to obtain an accumulated value. The accumulated value is reported to software executed by the graphics system for determination of an adjustment to the frame rate.

### TECHNICAL FIELD

Embodiments of the invention relate to a graphics system that computes a difference value between consecutive frames and dynamically adjusts the frame rate with high efficiency.

### BACKGROUND

In computer graphics, rendering is the process of producing images on a display device from descriptions of graphical objects or models. A graphics processing unit (GPU) renders 3D graphical objects, which is often represented by a combination of primitives such as points, lines, polygons, and higher order surfaces, into picture elements (pixels).

A GPU typically includes a rendering pipeline to perform the rendering operations. A rendering pipeline includes the following main stages: (1) vertex processing, which processes and transforms the vertices (that describe the primitives) into a projection space, (2) rasterization, which converts each primitive into a set of 3D pixels, which is aligned with the pixel grid on the display device with attributes such as 3D position, color, normal and texture, (3) fragment processing, which processes each individual set of 3D pixels, and (4) output processing, which combines the 3D pixels of all primitives into the 2D space for display.

A GPU outputs a sequence of rendered images (referred to as “frames”) at a given frame rate (i.e., the number of frames per second, a.k.a. “FPS”). The frame rate can be requested by an application that runs on the GPU. To ensure a highly dynamic visual experience, application designers such as gaming software designers may over-design the requested frame rate; e.g., 60 FPS, for all frames. However, the high frame rate often results in unnecessary frame updates such as when the displayed content is static (e.g., repeated or similar content). In the context of gaming software, static content may often occur when a game is in a loading stage or when a game menu is displayed. Reducing the frame rate, i.e., reducing the unnecessary frame updates, can save a significant amount of power consumed by the GPU. For example, forcing FPS from 60 to 30 may save 11%˜33% GPU power.

Therefore, there is a need for improving the frame rate design in a graphics system.

### SUMMARY

In one embodiment, a method is provided for a frame difference generator hardware in a graphics system for dynamically adjusting a frame rate. The method comprises: receiving graphics data of a tile of a current frame from a GPU in the graphics system, in parallel with a frame buffer receiving the graphics data; computing a difference value between a first value computed from the graphics data and a second value representing a corresponding tile of a previous frame; accumulating difference values computed from multiple tiles of the current frame and the previous frame to obtain an accumulated value; and reporting the accumulated value to software executed by the graphics system for determination of an adjustment to the frame rate.

In another embodiment, a graphics system is provided for dynamically adjusting a frame rate. The graphics system comprises: a GPU; and frame difference generator hardware coupled to the GPU. The frame difference generator is operative to: receive graphics data of a tile of a current frame from the GPU, in parallel with a frame buffer receiving the graphics data; compute a difference value between a first value computed from the graphics data and a second value representing a corresponding tile of a previous frame; accumulate difference values computed from multiple tiles of the current frame and the previous frame to obtain an accumulated value; and report the accumulated value to software executed by the graphics system for determination of an adjustment to the frame rate.

The embodiments of the invention enable a graphics system to dynamically adjust its frame rate to thereby achieve a significant amount of power saving.

### BRIEF DESCRIPTION OF THE DRAWINGS

The present invention is illustrated by way of example, and not by way of limitation, in the figures of the accompanying drawings in which like references indicate similar elements. It should be noted that different references to “an” or “one” embodiment in this disclosure are not necessarily to the same embodiment, and such references mean at least one. Further, when a particular feature, structure, or characteristic is described in connection with an embodiment, it is submitted that it is within the knowledge of one skilled in the art to effect such feature, structure, or characteristic in connection with other embodiments whether or not explicitly described.

FIG. 1 illustrates a graphics system in which embodiments of the invention may operate.

FIG. 2 illustrates a graphics system in further detail according to one embodiment.

FIG. 3 is a flow diagram illustrating a method for frame rate adjustment according to one embodiment.

FIG. 4 illustrates a frame difference generator according to one embodiment.

FIG. 5 is flowchart illustrating a method performed by frame difference generator hardware in a graphics system for dynamically adjusting a frame rate according to one embodiment.

### DETAILED DESCRIPTION

In the following description, numerous specific details are set forth. However, it is understood that embodiments of the invention may be practiced without these specific details. In other instances, well-known circuits, structures and techniques have not been shown in detail in order not to obscure the understanding of this description. It will be appreciated, however, by one skilled in the art, that the invention may be practiced without such specific details. Those of ordinary skill in the art, with the included descriptions, will be able to implement appropriate functionality without undue experimentation.

Embodiments of the invention provide a system and method for dynamically adjusting a frame rate in a graphics system. A hardware component, called frame difference generator (FDG), computes the difference between consecutive frames with high efficiency. The GPU sends graphics data of a frame, one tile at a time, to the FDG and to a frame buffer in parallel. The FDG computes a hash value representing each tile of a current frame, and compares hash values of corresponding tiles of two consecutive frames to compute a difference. The difference computed by the FDG is used to determine whether or not to adjust the current frame rate. Therefore, the graphics system may operate at a lower frame rate when the difference between consecutive frames is low; e.g., below a user-noticeable threshold.

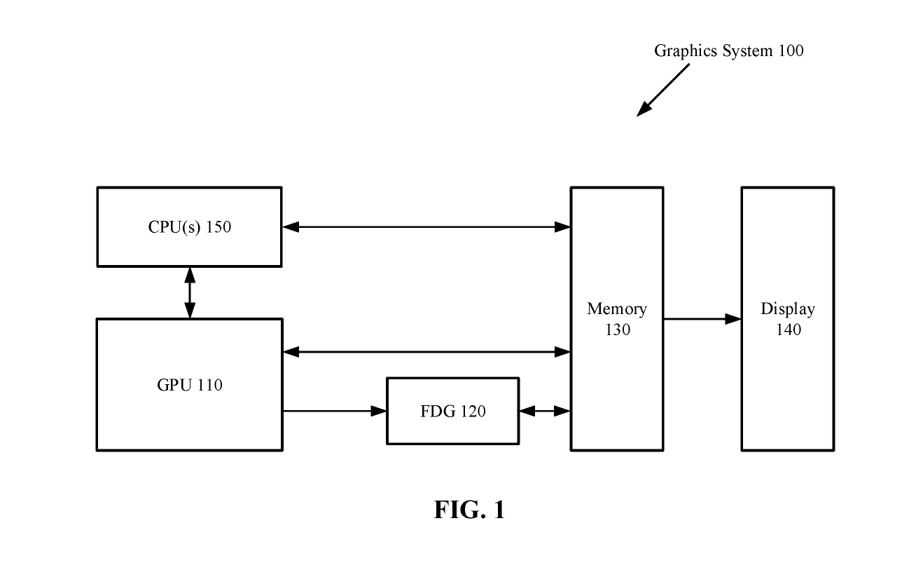

FIG. 1 illustrates a graphics system 100 in which embodiments of the invention may operate. The illustration of the graphics system 100 has been simplified; it is understood that graphics system 100 may include many more components that are omitted from FIG. 1 for ease of illustration. The graphics system 100 includes a GPU 110 for performing graphics processing; e.g., creating 2D raster representations of 3D scenes. The GPU 110 includes a combination of fixed-function hardware tailored for speeding up the computation, and general-purpose programmable hardware to allow for flexibility in graphics rendering. In some embodiments, the general-purpose programmable hardware is referred to as shader hardware. In addition to rendering graphics, the shader hardware can also perform general computing tasks.

In one embodiment, the graphics system 100 includes one or more central processing units (CPUs) 150. The CPUs 150 may issue commands to the GPU 110 to direct the GPU 110 to perform graphics computations. In some embodiments, the CPUs 150 and the GPU 110 may be integrated into a system-on-a-chip (SoC) platform. In one embodiment, the SoC platform may be part of a mobile computing and/or communication device (e.g., a smartphone, a tablet, a laptop, a gaming device, etc.), a desktop computing system, a server computing system, or a cloud computing system.

In one embodiment, the GPU 110 is coupled to a frame difference generator (FDG) 120, which compares consecutive frames to determine the difference or similarity of the frames. The FDG 120 is coupled to the tail end of the GPU 110 rendering pipeline. In one embodiment, the FDG 120 is part of the GPU 110; in an alternative embodiment, the FDG 120 is outside the GPU 110. The GPU sends the rendered graphics data to a frame buffer in a memory 130; e.g., dynamic random access memory (DRAM), or other volatile or non-volatile memory. A display 140 coupled to the memory 130 retrieves the graphics data from the memory 130 for display at a fixed refresh rate according to a synchronization signal (e.g., VSYNC at 60 Hz). This fixed refresh rate sets an upper limit on the frame rate, which is the rate at which the GPU 110 outputs consecutive frames. That is, if the frame rate goes above the refresh rate, the excess frames will not be displayed.

In one embodiment, the GPU 110 sends the graphics data of a current frame to the FDG 120 and the memory 130 in parallel. As such, the FDG 120 receives the graphics data directly from the GPU 110 without the overhead of memory access. The GPU 110 may process each frame one block (i.e., tile) at a time, where a tile corresponds to a fixed-sized area (e.g., 16 pixels by 16 pixels) in the display 140. That is, each frame is formed by a fixed number of tiles, all of which have the same size. After the graphics data of a tile is received by the FDG 120, the FDG 120 retrieves data of a corresponding tile (i.e., both tiles are at the same location in the respective frames) of the previous frame and generates a comparison result between the two tiles. The FDG 120 accumulates the comparison results of all corresponding tiles between the consecutive frames, and writes a final comparison result into the memory 130. The FDG 120 then reports to or notifies the graphics system 100 (e.g., software executed by the CPU 150) that the final comparison result is ready. The software determines whether the frame rate should be adjusted based on the final comparison result, and adjusts the frame rate accordingly, if necessary.

A graphics application may request a frame rate when it is executed by the graphics system 100. In one embodiment, the software of the graphics system 100 may use the requested frame rate as a base frame rate. If the comparison result from the FDG 120 shows that the difference between the consecutive frames is below a threshold, the frame rate will be adjusted lower than the base frame rate. Otherwise, the frame rate may stay at the base frame rate or be adjusted higher than the base frame rate, but not exceeding the refresh rate of the display 140.

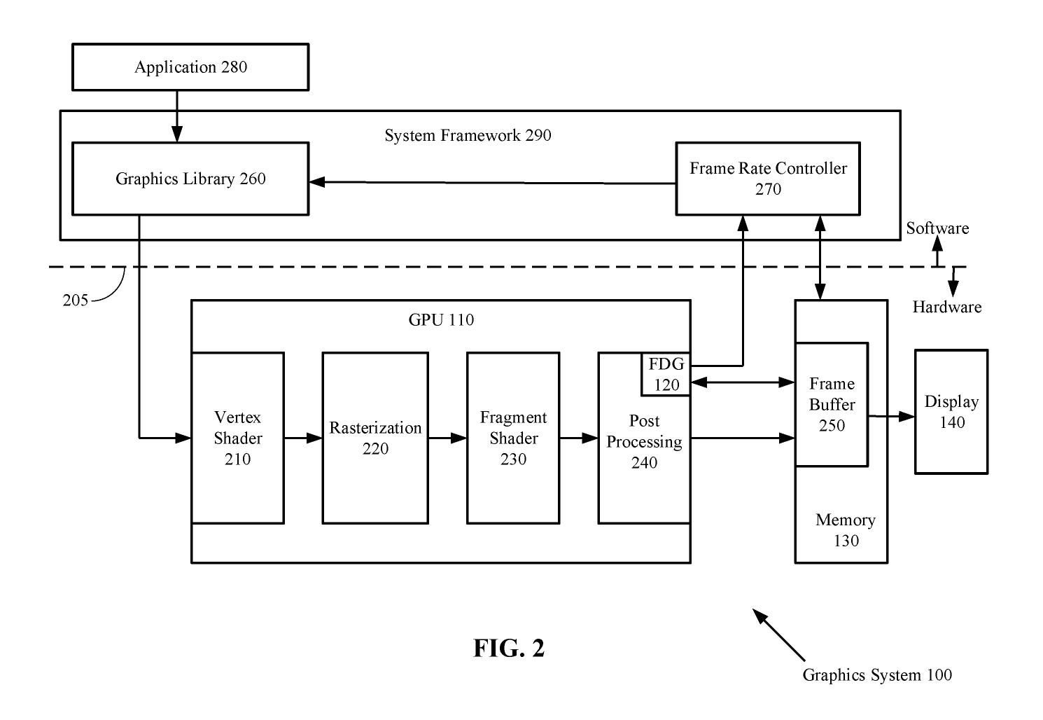

FIG. 2 illustrates the graphics system 100 in further detail according to one embodiment. The graphics system 100 is shown to include a software framework 290 that runs on a hardware platform. The software framework 290, as shown in this embodiment, includes all components above a dotted line 210; specifically, the software framework 290 as shown includes a frame rate controller 270, a graphics library 260, and one or more applications 280. Other system or user-space software components are omitted for simplification of the illustration. In one embodiment, the software in the software framework 290 may be executed on a host, such as the CPU(s) 150 (FIG. 1), which may assign tasks to the GPU 110 and other hardware components in the hardware platform.

The hardware platform includes all of the hardware components shown in FIG. 1. In the simplified illustration of FIG. 2, the hardware platform as shown includes the GPU 110, the FDG 120, the memory 130 and the display 140. The GPU 110 includes a number of pipeline stages: vertex shader 210, rasterization 220, fragment shader 230 and post-processing 240. Some of the pipeline stages 210-240 may be performed by the same hardware component; for example, unified shader hardware may be programmed to perform the operations of both the vertex shader 210 and the fragment shader 240.

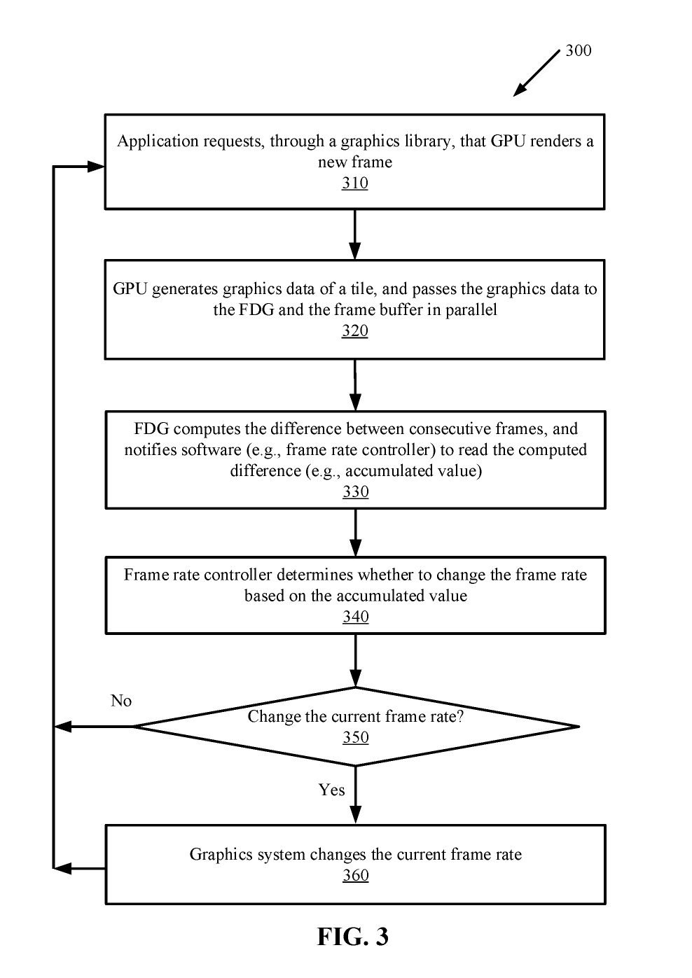

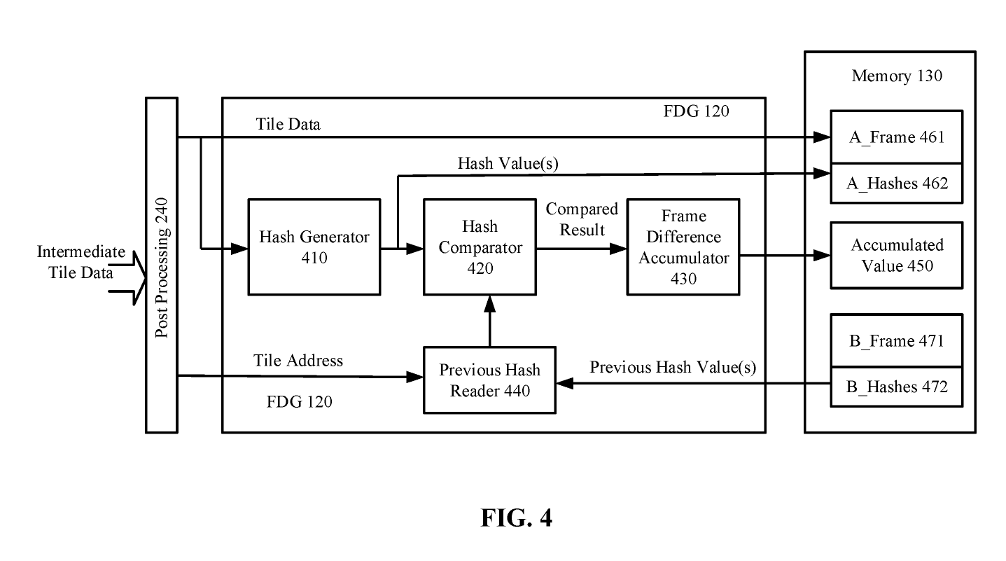

In one embodiment, the FDG 120 is part of the post-processing stage 240 of the GPU 110. When the graphics data of a tile is ready to go to a frame buffer 250, a copy of the graphics data is also sent to the FDG 120. The FDG 120 then performs the frame difference calculations, as will be described in more detail with reference to FIGS. 3 and 4.

FIG. 3 is a flow diagram illustrating a method 300 for frame rate adjustment according to one embodiment. The method 300 may be performed by the graphics system 100 of FIGS. 1 and 2. Referring also to FIG. 2, the method 300 begins when an application 280 requests, through the graphics library 260, that the GPU 110 renders a new frame (step 310), where the graphics library 260 functions as an interface layer between various applications 280 and the underlying graphics system 100. The application 280 may specify a frame rate. The GPU 110 generates graphics data of a tile, and passes the graphics data to the FDG 120 and the frame buffer 250 in parallel (step 320). The FDG 120 computes the difference between consecutive frames, and notifies software; e.g., the frame rate controller 270, to read the computed difference (step 330). In one embodiment, the computed difference is called the “accumulated value,” because it is a value accumulated over all corresponding tiles of the consecutive frames.

Based on the accumulated value, the frame rate controller 270 determines whether to change the current frame rate (step 340). In one embodiment, the graphics system 100 may operate at either of two frame rates; e.g., 60 FPS or 30 FPS, and the frame rate controller 270 may compare the computed difference with a threshold (TH1) to determine which frame rate is to be used; e.g., 30 FPS if the computed difference is less than TH1, and 60 FPS if the computed difference is greater than or equal to TH1. In another embodiment, the graphics system 100 may operate at one of multiple frame rates, and each frame rate is associated with a range of accumulated values. For example, FPS1 may be used if V1≤AV1<V2, FPS2 may be used if V2≤AV2<V3, FPS3 may be used if V3≤AV3<V4, etc., where V1<V2<V3<V4, FPS1<FPS2<FPS3, and AV1, AV2 and AV3 are different accumulated values. In one embodiment, the frame rate controller 270 may look up a table, which stores the different accumulated values and their corresponding FPS ranges, for determining whether to adjust the current frame rate, and the amount of frame rate adjustment.

If the current frame rate stays the same (step 350), the process returns to step 310 where the GPU 110 renders a next frame at the same frame rate. If the current frame rate is to be changed (step 350), the frame rate controller 270 may notify the graphics library 260 to adjust the frame rate, or to request the GPU 110 to adjust the frame rate. The graphics system 100 then renders the next frame or frames at the new frame rate (step 360).

FIG. 4 illustrates the FDG 120 in further detail according to one embodiment. The FDG 120 includes a hash generator 410, a hash comparator 420, a frame difference accumulator 430 and a previous hash reader 440. As used herein, the term “tile data” refers to a tile of graphics data generated by the GPU 110 and sent to the FDG 120; the term “intermediate tile data” refers to the graphics data generated by the GPU 110 before the graphics data reaches the post-processing stage 240; and the term “tile address” refers to the memory address or another type of location identifier that identifies the location of a tile in the memory 130 or in the frame.

In one embodiment, the intermediate tile data of a first tile of a current frame is processed by the post-processing stage 240 into tile data. The GPU 110 sends the tile data to the memory 130 (e.g., frame buffer) and the hash generator 410 in parallel. The GPU 110 also sends a tile address, which identifies the location or address of a second tile (also referred to as a corresponding tile) in a previous frame, where the first tile and the second tile have the same location and occupy the same area in the respective frames. The hash generator 410 generates a first hash value for the first tile, and the previous hash reader 440 retrieves a second hash value of the second tile from the memory 130. The hash comparator 420 compares the first hash value and the second hash value, and generates a difference value. The frame difference accumulator 430 accumulates the difference values over all the tiles in the current frame, and generates an accumulated value. After the last tile of the current frame is processed, the FDG 120 stores the accumulated value into the memory 130 as an accumulated value 450, and notifies the frame rate controller 270; e.g., by sending an interrupt, to retrieve the accumulated value 450. The frame difference accumulator 430 is then reset to zero.

In one embodiment, the hash value of a tile in the current frame (denoted as h_t) may be the error correction code value for the tile. The hash value of the corresponding tile in the previous frame is denoted as h_t_prev. The difference value (denoted as H_d) between the corresponding tiles of the two consecutive frames may be either one or zero, indicating whether the two corresponding tiles have different hash values; e.g., H_d=0 if (h_t=h_t_prev); or H_d=1 if (h_t≠h_t_prev). The accumulated value AV may indicate the number of different tiles between the two consecutive frames by: AV=AV+H_d/(number of tiles in a frame). In one embodiment, the accumulated value is reset to zero each time a new frame is processed.

In another embodiment, the hash value of a tile in the current frame (h_t) may be an average color value (or percentage) of the tile. For example, if the color resolution for each of the color components red (R), green (G) and blue (B) is 256, and the average color value across all the pixels in the tile is (R, G, B)=(128, 128, 128), then the h_t may be 128 or 50%. The hash value of the corresponding tile in the previous frame (h_t_prev) may be similarly computed. The color distance between the two frames may be computed as the difference between h_t and h_t_prev. The accumulated value AV may be computed by AV=AV+H_d/(number of tiles in a frame), where H_d=0 if (h_t=h_t_prev); or H_d=the color distance between h_t and h_t_prev if (h_t≠h_t_prev).

It is noted that in the previous examples of hash value comparison, the expression (h_t=h_t_prev) may be replaced by (|h_t−h_t_prev|<Tolerance), where Tolerance may be a value or a percentage. In one embodiment, the FDG 120 may report to the frame rate controller 270 not only how many tiles in a frame are different, but also the degree of difference; e.g., by reporting an accumulated value that indicates how different the two consecutive frames are.

Moreover, it is noted that in some cases, the GPU 110 may only write to a portion of a frame. Thus, the frame may contain one or more “un-processed” tiles; i.e., tiles that have no assigned or updated pixel values. In one embodiment, the aforementioned calculation of AV=AV+H_d/(number of tiles in a frame) may be replaced by AV=AV+H_d/(number of processed tiles in a frame), where the frame may be the current frame or the previous frame. A “processed tile” is a tile that contains at least a pixel value written by the GPU 110. Using the number of processed tiles for the averaging calculation may improve the result of difference comparison, as the tiles that do not contribute to the frame are removed from the calculation. It is also noted that the number of “processed tiles” may be different from one frame to the next. It is further noted that the GPU 110 may write the same or different pixels values to the corresponding tiles in two consecutive frames. Both of these corresponding tiles are “processed tiles,” whether or not their contents are the same.

In one embodiment, the FDG 120 may report to the frame rate controller 270 one or more of the following: the number of tiles in a frame, the number of processed tiles in a current (or previous) frame, and the number of tiles that are different between the current frame and the previous frame. In one embodiment, the frame rate controller 270 may perform the aforementioned AV calculation using the information reported by the FDG 120. The frame rate controller 270 may perform additional or alternative frame difference computations using the information reported by the FDG 120.

In one embodiment, the memory 130 may be set up to include a double buffer to store the current frame data and the previous frame data. In the embodiment of FIG. 4, the double buffer is shown as (A_frame, A_hashes) and (B_frame, B_hashes). When the current frame is processed in (A_frame, A_hashes), the previous frame and its hash values can be stored in (B_frame, B_hashes); and when the current frame is processed in (B_frame, B_hashes), the previous frame and its hash values can be stored in (A_frame, A_hashes).

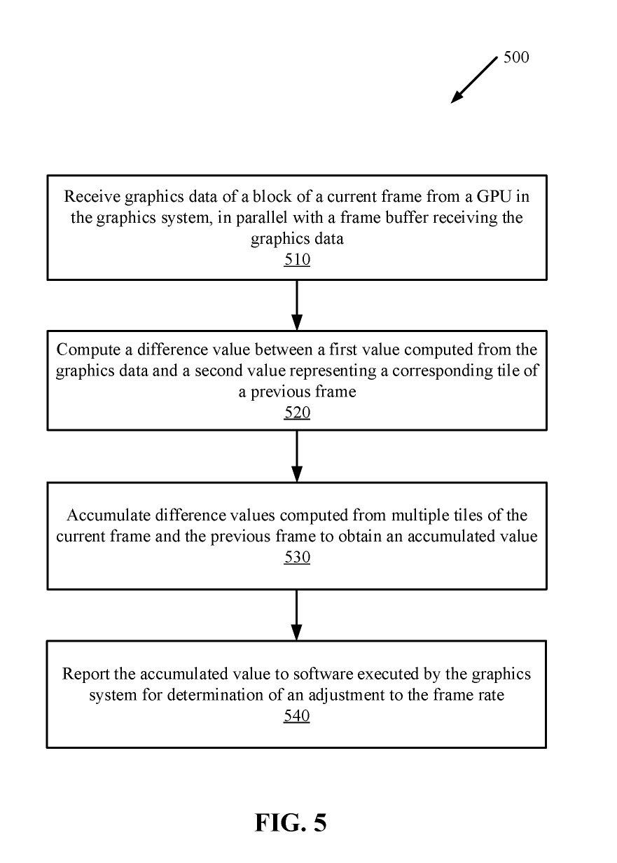

FIG. 5 is flowchart illustrating a method 500 performed by a hardware unit in a graphics system for dynamically adjusting a frame rate according to one embodiment. In some embodiments, the hardware unit may be the FDG 120 in FIGS. 1, 2 and 4. The method 500 begins with the FDG 120 receiving graphics data of a block of a current frame from a GPU in the graphics system, in parallel with a frame buffer receiving the graphics data (step 510). The FDG 120 computes a difference value between a first value computed from the graphics data and a second value representing a corresponding tile of a previous frame (step 520). The FDG 120 accumulates difference values computed from multiple tiles of the current frame and the previous frame to obtain an accumulated value (step 530). The FDG 120 then reports the accumulated value to software executed by the graphics system for determination of an adjustment to the frame rate (step 540).

The operations of the flow diagrams of FIGS. 3 and 5 have been described with reference to the exemplary embodiments of FIGS. 1, 2 and 4. However, it should be understood that the operations of the flow diagrams of FIGS. 3 and 5 can be performed by embodiments of the invention other than those discussed with reference to FIGS. 1, 2 and 4, and the embodiments discussed with reference to FIGS. 1, 2 and 4 can perform operations different than those discussed with reference to the flow diagrams. While the flow diagrams of FIGS. 3 and 5 shows a particular order of operations performed by certain embodiments of the invention, it should be understood that such order is exemplary (e.g., alternative embodiments may perform the operations in a different order, combine certain operations, overlap certain operations, etc.).

While the invention has been described in terms of several embodiments, those skilled in the art will recognize that the invention is not limited to the embodiments described, and can be practiced with modification and alteration within the spirit and scope of the appended claims. The description is thus to be regarded as illustrative instead of limiting.

1. A method performed by frame difference generator hardware in a graphics system for dynamically adjusting a frame rate, comprising:
receiving graphics data of a tile of a current frame from a graphics processing unit (GPU) in the graphics system, in parallel with a frame buffer receiving the graphics data;
computing a difference value between a first value computed from the graphics data and a second value representing a corresponding tile of a previous frame, wherein the difference value is averaged over a number of processed tiles, each processed tile containing at least a pixel value updated by the GPU;
accumulating difference values computed from multiple tiles of the current frame and the previous frame to obtain an accumulated value; and
reporting the accumulated value to software executed by the graphics system for determination of an adjustment to the frame rate.

2. The method of claim 1, wherein computing the difference value further comprises:
computing a first hash value representing the tile of the current frame;
retrieving a second hash value representing the corresponding tile of the previous frame from a memory; and
computing the difference value based on a difference between the first hash value and the second hash value.

3. The method of claim 2, wherein retrieving the second hash value further comprises:
receiving, by the frame difference generator hardware, an address of the corresponding tile of the previous frame from the GPU for retrieving the second hash value.

4. The method of claim 1, wherein the accumulated value indicates a color distance between corresponding tiles over all tiles of the current frame and the previous frame.

5. The method of claim 1, the accumulated value indicates a degree of difference between the current frame and the previous frame.

6. The method of claim 1, wherein the accumulated value indicates a number of different tiles between the current frame and the previous frame.

7. The method of claim 1, wherein accumulating the accumulated value further comprises:
storing the accumulated value to a memory after all tiles of the current frame are processed by the frame difference generator hardware; and
notifying the software that the accumulated value is ready for retrieval.

8. The method of claim 7, further comprising:
determining, by the software, an amount of the adjustment according to a predetermine threshold value or a table that specifies different ranges of accumulated values and corresponding frame rates.

9. The method of claim 1, wherein reporting the accumulated value further comprises:
reporting a number of processed tiles in the current frame, wherein each processed tile contains at least a pixel value written by the GPU.

10. The method of claim 1, wherein each of the current frame and the previous frame is formed by a plurality of tiles of a same size, and wherein the plurality of tiles are rendered by the GPU one tile at a time.

11. A graphics system for dynamically adjusting a frame rate, comprising:
a graphics processing unit (GPU); and
frame difference generator hardware coupled to the GPU, the frame difference generator operative to:
receive graphics data of a tile of a current frame from the GPU, in parallel with a frame buffer receiving the graphics data;
compute a difference value between a first value computed from the graphics data and a second value representing a corresponding tile of a previous frame, wherein the difference value is averaged over a number of processed tiles, each processed tile containing at least a pixel value updated by the GPU;
accumulate difference values computed from multiple tiles of the current frame and the previous frame to obtain an accumulated value; and
report the accumulated value to software executed by the graphics system for determination of an adjustment to the frame rate.

12. The graphics system of claim 11, wherein the frame difference generator hardware is further operative to:
compute a first hash value representing the tile of the current frame;
retrieve a second hash value representing the corresponding tile of the previous frame from a memory; and
compute the difference value based on a difference between the first hash value and the second hash value.

13. The graphics system of claim 12, wherein the frame difference generator hardware is further operative to receive an address of the corresponding tile of the previous frame from the GPU for retrieving the second hash value.

14. The graphics system of claim 11, wherein the accumulated value indicates a color distance between corresponding tiles over all tiles of the current frame and the previous frame.

15. The graphics system of claim 11, the accumulated value indicates a degree of difference between the current frame and the previous frame.

16. The graphics system of claim 11, wherein the accumulated value indicates a number of different tiles between the current frame and the previous frame.

17. The graphics system of claim 11, wherein the frame difference generator hardware is further operative to:
store the accumulated value to a memory after all tiles of the current frame are processed; and
notify the software that the accumulated value is ready for retrieval.

18. The graphics system of claim 17, wherein the software determines an amount of the adjustment according to a predetermine threshold value or a table that specifies different ranges of accumulated values and corresponding frame rates.

19. The graphics system of claim 11, wherein the frame difference generator hardware is further operative to report a number of processed tiles in the current frame, wherein each processed tile contains at least a pixel value written by the GPU.

20. The graphics system of claim 11, wherein each of the current frame and the previous frame is formed by a plurality of tiles of a same size, and wherein the plurality of tiles are rendered by the GPU one tile at a time.
